(19) United States
(12) Patent Application Publication
(10) Pub. No.: US 2012/0287249 A1
(43) Pub. Date: Nov. 15, 2012

(54) METHOD FOR OBTAINING DEPTH INFORMATION AND APPARATUS USING THE SAME

(75) Inventors: Hyon Gon CHOO, Daejeon-si (KR); Jin Woong KIM, Daejeon-si (KR); Jin Soo CHOI, Daejeon-si (KR); Sung Hoon KIM, Daejeon-si (KR)

(73) Assignee: Electronics and Telecommunications Research Institute, Daejeon (KR)

(21) Appl. No.: 13/470,836

(22) Filed: May 14, 2012

(30) Foreign Application Priority Data
May 12, 2011 (KR) 10-2011-0044330
May 11, 2012 (KR) 10-2012-0050469

(51) Int. Cl. H04N 13/02; H04N 5/33

(52) U.S. Cl. 348/47; 348/E13.074; 348/E05.09

(57) ABSTRACT

An apparatus of obtaining depth information is provided which includes a first sensor configured to obtain a first image, a second sensor configured to obtain a second image, an image information obtaining unit configured to obtain image information based on the first image and the second image, and a depth information obtaining unit configured to obtain depth information based on the image information, wherein the first sensor and the second sensor differ in type from each other.

### CROSS-REFERENCE TO RELATED APPLICATION

This application claims priority to Korean Patent Application No. 10-2011-0044330 filed on May 12, 2011, and No. 10-2012-0050469 filed on May 11, 2012, the contents of which are herein incorporated by reference in its entirety.

### TECHNICAL FIELD

Embodiments of the present invention are directed to methods of obtaining depth information and apparatuses of using the same, and more specifically to methods of obtaining 3D depth information for an object or scene using different types of image sensors and apparatuses of using the same.

### DISCUSSION OF THE RELATED ART

As 3D TVs or other 3D-related apparatuses evolve, demand for obtaining depth information for an object or scene increases.

Stereo matching methods, structured light based methods, and IR-based methods have been conventionally used to obtain depth information. The stereo matching methods use two cameras, and the IR-based methods measure time taken for IR beams emitted from a source and reflected by a target object to return to the source.

These conventional depth information obtaining methods are restricted in use in various image capturing environments. For example, the IR-based methods are advantageous in terms of real time provision of depth information with relatively high accuracy but suffer from not being able to provide depth information under the sunshine or other illuminations. The depth information obtaining methods using visible light or stereo cameras cannot guarantee accurate depth information for texture-free or repeated objects. The methods employing a laser can provide high accuracy but have disadvantages, such as restricted use for moving objects or long processing time.

### SUMMARY

The exemplary embodiments of the present invention provide a method of obtaining depth information usable in various image capturing environments and an apparatus of using the method. The exemplary embodiments also provide a method of obtaining depth information using different types of sensors and an apparatus of using the method.

1. An embodiment of the present invention relates to an apparatus of obtaining depth information. The apparatus includes a first sensor configured to obtain a first image, a second sensor configured to obtain a second image, an image information obtaining unit configured to obtain image information based on the first image and the second image and a depth information obtaining unit configured to obtain depth information based on the image information, wherein the first sensor and the second sensor differ in type from each other.

2. In 1, the first sensor may be an IR (Infrared) sensor, and the second sensor may be a visible light sensor.

3. In 1, the apparatus may further include a sensor controller configured to control the first sensor and the second sensor.

4. In 1, the apparatus may further include a depth information output unit configured to convert the depth information into 3-dimensional information and to output the 3-dimensional information.

5. Another embodiment of the present invention relates to a method of obtaining depth information. The method include obtaining a first image through a first sensor, obtaining a second image through a second sensor different in type from the first sensor, obtaining combined image information based on the first image and the second image and obtaining depth information based on the combined image information.

6. In 5, obtaining the combined image information may include determining a weight value for the first image based on reliability of the first image, determining a weight value for the second image based on reliability of the second image and obtaining the combined image information based on the weight values for the first image and the second image.

7. In 6, the weight value for the first image may be determined based on a frequency characteristic of the first image, and the weight value for the second image may be determined based on a frequency characteristic of the second image.

8. In 6, the weight value for the first image may be determined based on a statistical characteristic of the first image, and the weight value for the second image may be determined based on a statistical characteristic of the second image.

9. In 8, the statistical characteristic of the first image may be determined based on a distribution of the first image in a histogram for the first image, and the statistical characteristic of the second image may be determined based on a distribution of the second image in a histogram for the second image.

10. In 9, the depth information may be determined based on the histograms for the first image and the second image.

11. In 6, the first sensor may be an IR sensor, and the second sensor may be a visible light sensor, and in a daytime the weight value for the first image may be lower than the weight value for the second image, and at night, the weight value for the first image may be higher than the weight for the second image.

12. Yet another embodiment of the present invention relates to a method of obtaining depth information. The method includes obtaining a first image through a first sensor, obtaining a second image through a second sensor different in type from the first sensor, obtaining first image information based on the first image, obtaining second image information based on the second image and obtaining depth information based on the first image and the second image information.

13. In 12, obtaining the depth information may include obtaining first depth information based on the first image information, obtaining second depth information based on the second image information and obtaining final depth information based on the first depth information and the second depth information.

According to the embodiments of the present invention, depth information may be adaptively obtained by different types of sensors. Further, according to the embodiments, the depth information may be obtained in a robust manner against an environmental variation, which may occur due to a change in weather or illumination.

### BRIEF DESCRIPTION OF THE DRAWINGS

FIG. 1 is a block diagram illustrating a depth information obtaining apparatus according to an embodiment of the present invention.

FIGS. 2 and 3 are flowcharts illustrating a method of obtaining depth information according to an embodiment of the present invention.

FIG. 4 shows an example of obtaining combined image information based on a histogram regarding output images.

### DESCRIPTION OF THE EMBODIMENTS

The embodiments of the present invention will be described in detail with reference to the accompanying drawings.

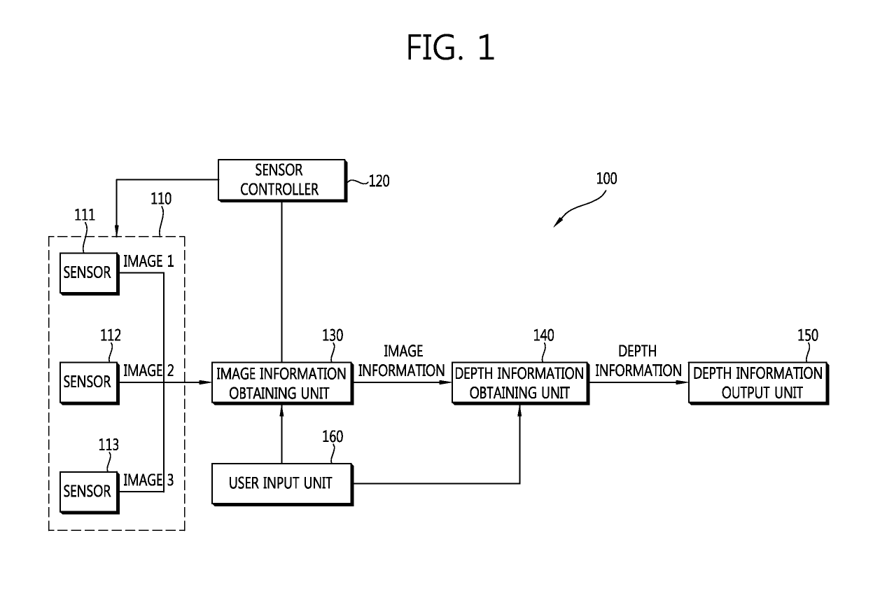

FIG. 1 is a block diagram illustrating a depth information obtaining apparatus according to an embodiment of the present invention. Referring to FIG. 1, the depth information obtaining apparatus 100 may include a sensor unit 110 having different types of sensors 111, 112, and 113, a sensor controller 120, an image information obtaining unit 130, a depth information obtaining unit 140, a depth information output unit 150, and a user input unit 160.

The sensors 111, 112, and 113 included in the sensor unit 110 sense light sources having different wavelengths and characteristics, obtain images, and transfer the obtained images to the image information obtaining unit 130. Depending on the type of the sensed light sources, the sensors 111, 112, and 113 may include IR (Infrared) sensors, visible light sensors, laser sensors, UV (Ultra Violet) sensors, or microwave sensors. The sensor unit 110 includes two or more types of sensors to obtain images. For example, the sensor unit 110 includes three sensors 111, 112, and 113 as shown in FIG. 1. The number and type of the sensors included in the sensor unit 110 are not limited thereto, and the sensor unit 110 may include two or more different types of sensors.

The sensor controller 120 generates a control signal for illumination or synchronization and controls the sensor unit 110 through the control signal.

The image information obtaining unit 130 receives the images from the sensor unit 110, analyzes the received images and outputs image information. The image information may include the images obtained by the sensors and a result of analysis of the images and is transferred to the depth information obtaining unit 140.

The depth information obtaining unit 140 obtains depth information based on the image information from the image information obtaining unit 130 and transfers the depth information to the depth information output unit 150.

The depth information output unit 150 converts the depth information into a format needed for a user. For example, the depth information may be turned into 3-dimensional (3D) information.

The user input unit 160 receives information necessary for adjustment of the sensors, obtaining of images, and depth information from the user and controls output of the depth information.

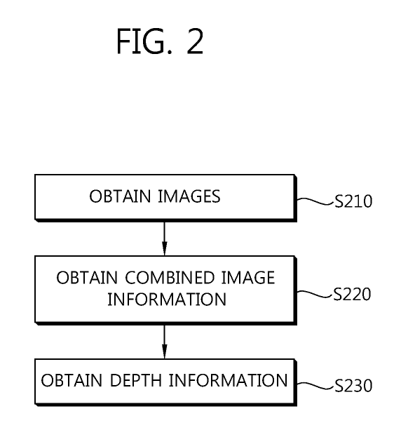

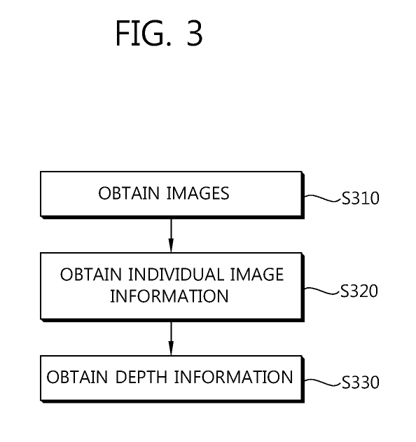

FIGS. 2 and 3 are flowcharts illustrating a method of obtaining depth information according to an embodiment of the present invention.

Different from the conventional methods, the method according to an embodiment obtains information for obtaining depth information using different types of sensors and analyzes the information to obtain the depth information. To obtain the depth information, combined image information of the images transferred from the different types of sensors may be used as shown in FIG. 2 or individual image information of each of the images transferred from the different types of sensors may be used as shown in FIG. 3.

Referring to FIG. 2, the depth information obtaining apparatus senses light sources using the different types of sensors and obtains images (S210). For example, when having an IR sensor and a visible light sensor, the depth information obtaining apparatus obtains an IR image through the IR sensor and a visible light image from the visible light sensor.

The depth information obtaining apparatus obtains combined image information based on the images obtained in step S210 (S220). The depth information obtaining apparatus may analyze the obtained images to determine weight values.

For example, in the case of the depth information obtaining apparatus having an IR sensor and a visible light sensor, an output image from the visible light sensor appears better during the daytime while an output image from the IR sensor does not because of being saturated by sunshine. In contrast, at night, the IR sensor outputs a better image than the visible light sensor does. Thus, the visible light sensor, in the daytime, and the IR sensor, at night, has higher-reliable output images. Accordingly, the depth information obtaining apparatus having both the IR sensor and the visible light sensor may put a more weight value on an output image from the visible light sensor in the daytime and on an output image from the IR sensor at night.

The depth information obtaining apparatus may identify whether the images belong to a normal range to determine the weight values for the images received from the sensors. As one example, the depth information obtaining apparatus may analyze frequency characteristics of the output images from the sensors. That images received from the sensors have a high output in a high frequency band or a specific frequency band means that the images have high reliability. Thus, the depth information obtaining apparatus may determine weight values for the images based on the output images in a high frequency band or in a specific frequency band. The depth information obtaining apparatus may obtain a response through a high-pass filter or a band-pass filter which is commonly used for signal processing and may analyze the frequency characteristics based on the response.

As another example, the depth information obtaining apparatus may analyze statistical characteristics on the output images from the sensors. When in a histogram which shows statistical characteristics of the output images, an output image concentrates on a specific region, it means that the reliability is low. Accordingly, when the output image does so, the depth information obtaining apparatus may put a lower weight value on the output image. In contrast, when an output image spreads over a wide range, it means that the reliability is high, and the depth information obtaining apparatus may thus put a higher weight value on the output image.

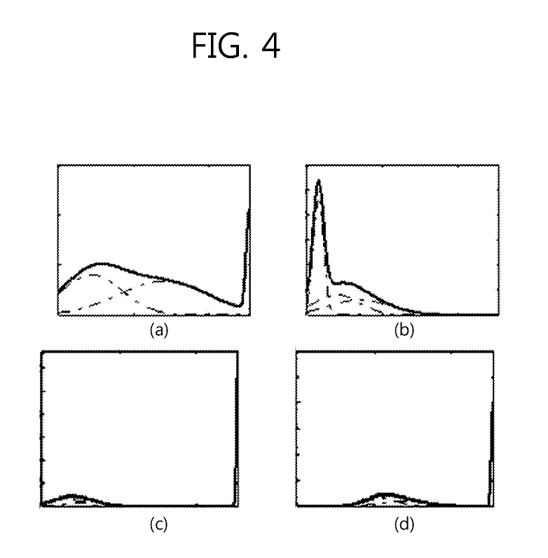

FIG. 4 shows an example of obtaining combined image information based on a histogram regarding output images. In FIG. 4, an x axis refers to a range of an output level of an image, and a y axis refers to a probability distribution for the output.

Referring to FIG. 4, histograms (denoted in dashed-lines) for the output images from the sensors are analyzed.

For the analysis, a Gaussian mixture model may be used, which models the histograms as a sum of Gaussian functions. The depth information obtaining apparatus may obtain a distribution of the histogram based on the variance and strength of the Gaussian function.

Turning back to FIG. 2, the depth information obtaining apparatus obtains depth information based on the combined image information obtained in step S220.

As described above, the depth information obtaining apparatus may obtain the depth information based on individual image information from the respective images received from the different types of sensors as shown in FIG. 3.

Returning to FIG. 3, the depth information obtaining apparatus senses light sources through different types of sensors and obtains images (S310). For example, when having an IR sensor and a visible light sensor, the depth information obtaining apparatus obtains an IR image through the IR sensor and a visible light image from the visible light sensor.

The depth information obtaining apparatus obtains image information for each of the images obtained in step S310 (S320). In other words, the depth information obtaining apparatus obtain individual image information for each of the images transferred from the different types of sensors.

The depth information obtaining apparatus obtains depth information based on the individual image information obtained in step S320. The depth information obtaining apparatus may obtain the individual depth information based on parameters for each sensor and the image from each sensor. The final depth information may be acquired by combining the individual depth information with weigh values determined based on the reliability of each sensor.

The following Equation 1 represents an example of obtaining the final depth information based on the individual depth information and weight values:

$${f}_{total} ( x , y ) = {\sum }_{j = 1}^{n} \{ {w}_{i} {f}_{i} ( j ) \} \qquad [ Equation 1 ]$$

where wᵢ is the weight value for each sensor, and the sum of the weight values is 1. In the above procedure, in relation to obtaining the depth information, the images may be combined with each other or may undergo filtering.

ƒₜₒₜₐₗ(x, y)=g(wᵢƒᵢ(j), wᵢ₊₁ƒᵢ₊₁(j))+wᵢ₊₂ƒᵢ₊₂(j) [Equation 2]

In the above procedure, g(.) denotes a filtering function which may include modifying the output from a specific sensor in a dynamic range or noise removal.

As used herein, each component representing one unit that performs a specific function or operation may be implemented in hardware, software, or a combination thereof.

The above-described apparatus and method may be implemented in hardware, software, or a combination thereof. In the hardware implementation, one component may be implemented in an application specific integrated circuit (ASIC), a digital signal processor (DSP), a digital signal processing device (DSPD), a programmable logic device (PLD), a field programmable gate array (FPGA), a processor, a controller, a microcontroller, a microprocessor, or a combination thereof. In the software implementation, the above-described method may be implemented to include modules performing respective corresponding functions. The modules may be stored in a memory and executed by a processor. The memory may be positioned inside or outside the processor or may be connected to the processor through a known means.

In the system, the method may be written in a computer program. Codes or code segments included in the program may be easily inferred by one of ordinary skill in the art to which the invention pertains. The program may be stored in a computer-readable recording medium, read and executed by the computer. The computer-readable recording medium may include all types of storing media, such as CDs (Compact Discs), DVDs (Digital Video Discs), or other tangible media, or intangible media, such as carriers.

Various modifications or variations may be made to the embodiments by one of ordinary skills, which are included in the scope of the invention without departing from the technical scope of the invention defined by the appended claims.

What is claimed is:

1. An apparatus of obtaining depth information comprising:
a first sensor configured to obtain a first image;
a second sensor configured to obtain a second image;
an image information obtaining unit configured to obtain image information based on the first image and the second image; and
a depth information obtaining unit configured to obtain depth information based on the image information,
wherein the first sensor and the second sensor differ in type from each other.

2. The apparatus of claim 1, wherein the first sensor is an IR(Infrared) sensor, and the second sensor is a visible light sensor.

3. The apparatus of claim 1, further comprising a sensor controller configured to control the first sensor and the second sensor.

4. The apparatus of claim 1, further comprising a depth information output unit configured to convert the depth information into 3-dimensional information and to output the 3-dimensional information.

5. A method of obtaining depth information, the method comprising:
obtaining a first image through a first sensor;
obtaining a second image through a second sensor different in type from the first sensor;
obtaining combined image information based on the first image and the second image; and
obtaining depth information based on the combined image information.

6. The method of claim 5, wherein obtaining the combined image information includes,
determining a weight value for the first image based on reliability of the first image;
determining a weight value for the second image based on reliability of the second image; and
obtaining the combined image information based on the weight values for the first image and the second image.

7. The method of claim 6, wherein the weight value for the first image is determined based on a frequency characteristic of the first image, and the weight value for the second image is determined based on a frequency characteristic of the second image.

8. The method of claim 6, wherein the weight value for the first image is determined based on a statistical characteristic of the first image, and the weight value for the second image is determined based on a statistical characteristic of the second image.

9. The method of claim 8, wherein the statistical characteristic of the first image is determined based on a distribution of the first image in a histogram for the first image, and the statistical characteristic of the second image is determined based on a distribution of the second image in a histogram for the second image.

10. The method of claim 9, wherein the depth information is determined based on the histograms for the first image and the second image.

11. The method of claim 6, wherein the first sensor is an IR sensor, and the second sensor is a visible light sensor, and wherein in a daytime the weight value for the first image is lower than the weight value for the second image, and at night, the weight value for the first image is higher than the weight for the second image.

12. A method of obtaining depth information, the method comprising:
obtaining a first image through a first sensor;
obtaining a second image through a second sensor different in type from the first sensor;
obtaining first image information based on the first image;
obtaining second image information based on the second image; and
obtaining depth information based on the first image and the second image information.

13. The method of claim 12, wherein obtaining the depth information includes,
obtaining first depth information based on the first image information;
obtaining second depth information based on the second image information; and
obtaining final depth information based on the first depth information and the second depth information.
